(19) United States
(12) Patent Application Publication
(10) Pub. No.: US 2014/0249663 A1
(43) Pub. Date: Sep. 4, 2014

(54) SYSTEM AND METHOD FOR CONTROLLING THE QUALITY OF AN OBJECT

(71) Applicant: EUROPEAN AERONAUTIC DEFENCE AND SPACE COMPANY EADS FRANCE, Paris (FR)

(72) Inventor: Hubert Voillaume, Issy Les Moulineaux (FR)

(73) Assignee: European Aeronautic Defence and Space Company Eads France, Paris (FR)

(21) Appl. No.: 14/349,187

(22) PCT Filed: Oct. 16, 2012
(86) PCT No.: PCT/EP2012/070510

§ 371 Date: Apr. 2, 2014

(30) Foreign Application Priority Data
Oct. 17, 2011 (FR) 1159357

(51) Int. Cl. G05B 15/02

(52) U.S. Cl. CPC G05B 15/02
USPC 700/109

(57) ABSTRACT

A system for controlling the quality of an object leaving a production facility. The system includes a chamber including an inlet port through which the object to be inspected is inserted into the chamber and at least one outlet port, the chamber having an inspection zone, a transport device for conveying the object to be inspected into the inspection zone and for releasing same through the at least one outlet port, a weighing apparatus for weighing the object in the inspection zone, an assembly for the contact-free dimensional measuring of the object in the inspection zone, and an assembly for analysing the structure of the object in the inspection zone by means of laser beams and/or X-rays. The chamber is made from a material that is opaque for the wavelengths of the laser beams during operation and the X-rays, in order to prevent any radiation leakage.

### CROSS-REFERENCE TO RELATED APPLICATIONS

This application is the National Stage of International Application No. PCT/EP2012/070510 having International filing date, 16 Oct. 2012, which designated the United States of America, and which International Application was published under PCT Article 21 (s) as WO Publication 2013/057115 A1 and which claims priority from, and benefit of, French Application No. 1159357 filed on 17 Oct. 2011, the disclosures of which are incorporated herein by reference in their entireties.

### BACKGROUND

The presently disclosed embodiment relates to a system and a method for assessing the quality of an object manufactured, in particular, on a high-rate production line.

Some industrial fields such aeronautics or aerospace require that each piece forming a structure is produced with extremely high precision in the dimensions thereof, the shape thereof or the surface appearance thereof and confirmation that each of these pieces properly meets the required manufacturing limits.

Indeed, it is essential in technical fields such as the aeronautics field to make sure there are no faults in a piece such that said fault does not spread following requests for service.

Therefore, various methods are known which allow the manufacturing quality of a piece or product to be assessed.

The manual inspection of the pieces or products coming from an assembly line is rarely carried out in industrial fields such as aeronautics, since it is too time-consuming and certain faults are, moreover, difficult to spot with the naked eye such that a manual control depends mainly on the experience of the control inspector.

These manual interventions are therefore long, costly and present an error margin which is not compatible with the consistently stricter requirements of the industrial fields such as aeronautics and space.

Automated control methods are also known including, in particular, that which uses tracing devices in order to determine the dimensions and the shape of a piece or of a finished product.

However, these tracing devices are complex, quite inflexible and quite unsuitable for pieces having small dimensions.

Moreover, the control of these small pieces, when they have a complex shape, is extremely difficult to automate.

Automation also requires programming which can prove to be heavy.

Methods for assessing the quality of a piece using ultrasound are also known.

However, a small deviation in the geometry of the piece or product, which is acceptable for the quality criteria, can lead to unacceptable positioning problems when it is a question of ultrasound control since the sound beam must be constantly perpendicular to the surface of this piece or of this product.

### SUMMARY

The aim of the presently disclosed embodiment is, therefore, to propose a system and a method for the automatic assessment of the quality of a product or of a piece coming from an assembly line, which are simple in the design thereof and in the operating mode thereof, quick and allow all of the control and assessment operations to be grouped together on a single station in order to make savings on the recurrent labor costs and on the cycle times.

In particular, the aspects of the disclosed embodiment relate to a system for automatically and flexibly assessing the quality of a product or of a piece which is capable of coping with high manufacturing rates while protecting the operator(s) present on the assembly line from possible leakage of laser light which could arise from the laser beams being reflected on the piece or the product to be inspected, particularly when the latter have complex shapes.

Another object of the presently disclosed embodiment is a facility for manufacturing a piece or a product or an assembly comprising such a control system located at a line end.

To this end, the aspects of the disclosed embodiment relate to a system for controlling the quality of an object.

According to the aspects of the disclosed embodiment, this control system comprises:
a safety chamber including an inlet port through which said object to be inspected is inserted into said chamber and at least one outlet port, said chamber having an inspection area,
a transport device for carrying said object to be inspected into said inspection area and removing same through said at least one outlet port,
a weighing apparatus for weighing said object in said inspection area,
an assembly for the contact-free dimensional measuring of the object in said inspection area,
an assembly for analyzing the structure of the object in said inspection area by means of laser beams, and/or X-rays, respectively, and
said safety chamber is made from a material that is opaque for the wavelengths of said laser beams in operation, and for the wavelengths of said laser beams in operation and said X-rays, respectively, in order to prevent any radiation leakage.

Therefore, this control system advantageously allows all of the steps for assessing the quality of a piece, a product or an assembly to be concentrated on a single station. It also ensures the protection of the operator(s) working on the assembly line from accidental leaks of laser light and/or X-rays.

In various particular embodiments of this assessment system, each having particular advantages thereof which can have numerous possible technical combinations:
since said transport device includes a conveying strip, said weighing device is placed under this strip,
the assembly for analyzing the structure of the object in said inspection area comprises an X-ray source and a sensor, the object to be inspected being placed in said inspection area between said X-ray source and said sensor,
said assembly for the contact-free dimensional measuring of the object in said inspection area comprises an assembly for dimensional measuring by laser interferometry and/or an assembly for measuring by projection of a light pattern and detection by a stereovision system,
the system comprises a presence detector in order to stop said transport device when the object to be inspected is placed in said inspection area,
since said weighing apparatus transmits a signal in response to said object being weighed, and said assembly for the contact-free dimensional measuring of the object transmits a signal for the dimensional measuring of the object and said assembly for analyzing the structure of the object transmits a signal relating to the structural analysis measurement of said object, the system includes a central processing unit connected to a recording medium comprising at least one information file which has been previously recorded on this recording medium in order to define the reference parameters of said object, said central processing unit receiving each of said signals in order to compare them with said reference parameters,
the system comprises a device for marking said object when the assessment of the quality thereof reveals one or more faults,
the system further comprises a control assembly for the surface appearance of the object and/or an optical coherence tomography (OCT) device.

The latter device allows, for example, control of the resin flashes in the rays of the folded curved pieces.

The aspects of the disclosed embodiment also relate to a facility for the production of an object, this facility being provided with a system for controlling the quality of this object as described above.

The aspects of the disclosed embodiment also relate to a method for assessing the quality of an object wherein said object is positioned in an inspection area, then at least the first of the following steps is carried out on this object placed in this inspection area:
a) said object is weighed,
b) contact-free dimensional measuring of said object is carried out,
c) structural analysis of said object is carried out, and
at the end of each of these steps, the obtained result is compared with one or more reference measurements, and if they correspond, taking into account measuring uncertainties, then the next step is undertaken, and if they are different then the object is discarded.

Advantageously, the surface appearance of this object is moreover subjected to control.

Preferably, at the step for the structural analysis of said object, a first laser beam is directed onto said object in order to produce ultrasonic waves in said object to be inspected, said object is illuminated with a second laser beam such that part of this second beam is reflected by said object and this reflected part of the second beam is measured by interferometry, all of these laser beams passing through a same optical pickup.

### BRIEF DESCRIPTION OF THE DRAWINGS

The aspects of the disclosed embodiment will be described in greater detail with reference to the appended drawings wherein:

FIG. 1 schematically shows in profile a system for controlling the quality of an object according to a particular embodiment of the aspects of the disclosed embodiment;

FIG. 2 is a partial enlarged view of the transport device of FIG. 1.

### DETAILED DESCRIPTION

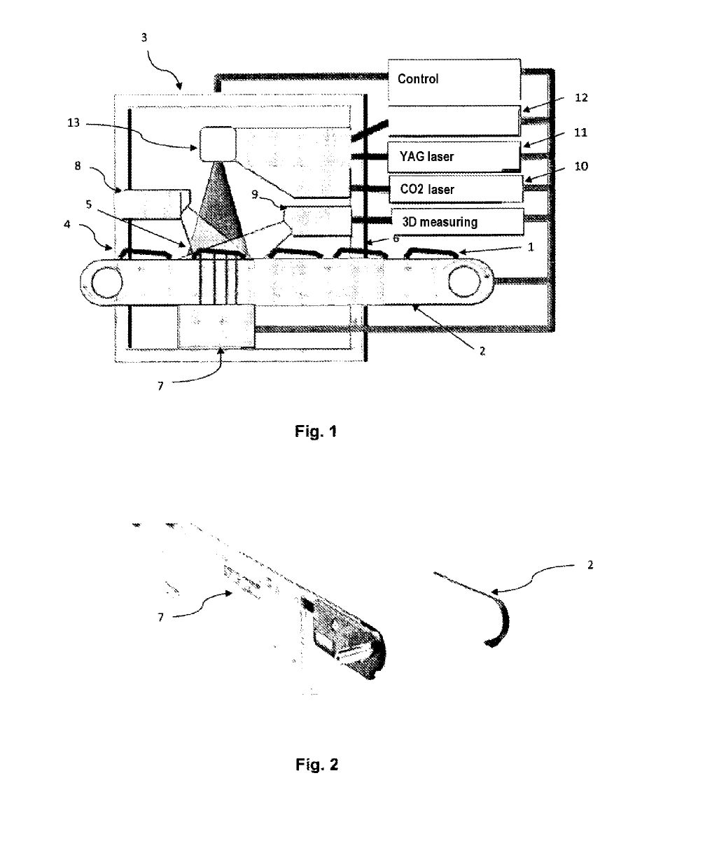

FIGS. 1 and 2 schematically show a system for controlling the quality of an object according to a preferred aspect of the disclosed embodiment.

This control system is placed at the end of a line for producing products 1, the products being carried to the system by a conveying device 2 which, in this case, is a conveying belt. The products 1 to be inspected are placed on this conveying belt with no extremely precise positioning.

Each product 1 enters a safety chamber 3 via an inlet port 4 of this chamber, reaches an inspection area 5 of this chamber where it is detected by a presence detector (not shown) which then stops the conveying device 2 in order to allow the assessment of the quality thereof.

The product 1 to be inspected which is located in the inspection area 5 is ready to be sequentially assessed by an arrangement of measuring and control devices.

At the end of this assessment of the quality of the product 1 and if the latter is found to comply with the manufacturing limits both in terms of dimensions and quality of surface and shape, the conveying device 2 restarts and removes the product via an outlet port 6.

If it is analyzed as being non-compliant, the defective product is marked by a marking device (not shown) prior to the removal thereof via the outlet port 6. By way of illustration, the product 1 which has one or more faults can be marked by spraying a paint at the surface thereof.

In a first step for assessing the quality of the product 1 coming from the production line, the product 1 to be inspected is weighed by a weighing apparatus 7. In this case, the weighing apparatus 7 is scales placed under the conveying belt 2.

This weighing of the product 1 can allow pre-sorting of the products 1 in the case of a fault. An overload of product 1 in relation to a reference weight can signify the presence of a foreign body. Conversely, an underload of the product 1 in relation to this reference weight can signify the presence of air bubbles and/or an excessive porosity thereof.

To carry out this comparison, the weighing apparatus 7 provides an electrical signal in response to product 1 being weighed, this electrical signal representing the weight of the product 1 which has been determined in this manner being sent to a central processing unit (not shown) connected to a recording medium (not shown) comprising at least one data file or a library of data files previously recorded on this recording medium in order to define the reference parameters of the product 1 to be inspected.

This central processing unit includes, in this case, a microprocessor configured to carry out the comparison between the measuring signals received from the various assessment devices of the system and the reference parameters.

If the measured weight is equal to the reference weight, taking into account measurement uncertainties, then the three-dimensional measurements of this product 1 are determined using an assembly for the contact-free dimensional measuring of the product 1 placed in the inspection area 5.

This contact-free dimensional measuring assembly comprises, in this case, an assembly for measuring by projection of a light pattern such as a strip or a cross at the surface of the product 1 and the detection of this light pattern by a stereovision system including at least two cameras 8, 9 simultaneously taking shots of the light pattern projected at the surface of the product 1. These cameras 8, 9 are, for example, CCD matrix cameras.

Since this dimensional measuring method is known from the prior art, it will not be described in detail below. It will simply be stated that stereovision allows the spatial position of points to be determined from the coordinates of the images thereof in two different views so as to produce three-dimensional measurements of the product 1.

Each of these cameras 8, 9 sends a signal representing the measurement acquired by the corresponding camera to the central processing unit which determines the dimensions of the product 1 from these signals. These dimensions are then compared with the reference dimensions of the product 1 which are stored on the recording medium.

If the dimensions of the product 1 which are determined in this manner correspond to the reference dimensions, taking into account measurement uncertainties, then the structure of the product 1 present in the inspection area 5 is analyzed.

To this end, an assembly for analyzing the structure of the object in said inspection area is used, which comprises:
a first laser source 10 for producing a first laser beam in order to create ultrasonic waves in the product 1,
a second laser source 11 for producing a second laser beam in order to illuminate the product 1 to be inspected,
an interferometer 12 for measuring part of the second beam, which part is reflected by the product 1 placed in the inspection area 5, wherein this interferometer 12 can produce an electrical signal representing this measurement, which signal is sent to the central processing unit for comparison with a reference parameter.

These first and second laser sources 10, 11 and the interferometer 12 are optically coupled with a measuring head 13 placed in the chamber 3, this measuring head 13 including an optical scanner for sweeping the surface of the product 1 to be inspected. This optical scanner comprises, in this case, two mirrors mounted on a galvanometer.

The first laser source 10, which is, in this case, a carbon dioxide (CO₂) laser, produces a first laser beam with a wavelength of 10.6 μm having an energy of approximately 200 mJ. This first beam is received by the optical scanner of the measuring head 13 which directs it towards the product 1 placed in the inspection area 5 in order to allow this product 1 to be scanned. This first laser beam produces ultrasonic waves in the product 1 to be inspected.

The second beam emitted by the second laser source 11 coupled optically with the same optical measuring head 13 is also sent by this measuring head 13 towards the product 1 to be inspected. Part of this second beam is then reflected by the product 1 while being dephased by the ultrasonic waves produced by the first beam in this product 1.

The reflected laser beam is then received by the interferometer 12 which can produce an electrical signal representing this reflected beam part which has been measured in this manner. This electrical signal is sent to the central processing unit for processing in order to be compared with one or more reference parameters of the product 1.

If the product 1 proves to be compliant, the conveying belt 2 moves forward in order to remove this product 1 and place, in the inspection area 5, a new product 1 to be inspected.

Alternately, the optical scanner can include a single mirror for sweeping along an axis perpendicular to the longitudinal axis of the conveying belt 2. The conveying belt is then used as a second sweeping axis such as to allow each product 1 to be scanned.

The second laser beam is emitted, in this case, by a diode-pumped solid-state laser, such as a Nd:YAG laser emitting a laser beam with a wavelength λ=1064 nm and a power typically of 150 W. The interferometer 12 is, in this case, a Fabry-Perot interferometer and/or a two-wave mixing (TWM) interferometer.

The safety chamber 3 is produced from a material that is opaque for the wavelengths of the laser beams in operation in order to prevent any leakage of laser light which can be harmful to the health of the operators working on the production line.

1. A system for controlling the quality of an object, comprising:
a safety chamber including an inlet port through which said object to be inspected is inserted into said chamber and at least one outlet port, said chamber having an inspection area,
a transport device for carrying said object to be inspected into said inspection area and removing same through said at least one outlet port,
a weighing apparatus for weighing said object in said inspection area,
an assembly for the contact-free dimensional measuring of the object in said inspection area, comprising an assembly for dimensional measuring by laser interferometry and/or an assembly for measuring by projection of a light pattern and detection by a stereovision system,
an assembly for analyzing the structure of the object in said inspection area by means of laser beams, and/or X-rays, respectively, and in that
said safety chamber is made from a material that is opaque for the wavelengths of said laser beams in operation, and for the wavelengths of said laser beams in operation and said X-rays, respectively, in order to prevent any radiation leakage.

2. The system as claimed in claim 1, wherein said assembly for analyzing the structure of the object in said inspection area comprises:
a first laser source for producing a first laser beam in order to create ultrasonic waves in said object to be inspected,
a second laser source for producing a second laser beam in order to illuminate said object to be inspected,
an interferometer for measuring part of the second beam, which part is reflected by said object to be inspected, wherein said interferometer can produce an electrical signal relating to this measurement,
said laser sources and said interferometer being optically coupled with an optical measuring head placed in said chamber, said measuring head including an optical scanner.

3. The system as claimed in claim 1, wherein said assembly for analyzing the structure of the object in said inspection area comprises an X-ray source and a sensor, the object to be inspected positioned in said inspection area being placed between said X-ray source and said sensor.

4. The system as claimed in claim 1, wherein it comprises a presence detector in order to stop said transport device when the object to be inspected is placed in said inspection area.

5. The system as claimed in claim 1, wherein since said weighing apparatus transmits a signal in response to said object being weighed, and said assembly for the contact-free dimensional measuring of the object transmits a signal for the dimensional measuring of the object and said assembly for analyzing the structure of the object transmits a signal relating to the structural analysis measurement of said object, the system includes a central processing unit connected to a recording medium comprising at least one information file which has been previously recorded on this recording medium in order to define the reference parameters of said object, said central processing unit receiving each of said signals in order to compare them with said reference parameters.

6. The system as claimed in claim 1, wherein it comprises a device for marking said object when the assessment of the quality thereof reveals one or more faults.

7. The system as claimed in claim 1, wherein it further comprises a control assembly for the surface appearance of the object and/or an optical coherence tomography device.

8. A facility for the production of an object, which facility is provided with a system for controlling the quality of said object as claimed in claim 1.

9. A method for assessing the quality of an object wherein said object is positioned in an inspection area, then at least the first of said following steps is carried out on this object placed in this inspection area:
a) said object is weighed,
b) contact-free dimensional measuring of said object in said inspection area is carried out with an assembly for contact-free dimensional measuring comprising an assembly for dimensional measuring by laser interferometry and/or an assembly for measuring by projection of a light pattern and detection by a stereovision system,
c) structural analysis of said object is carried out, and in that
at the end of each of these steps, the obtained result is compared with one or more reference measurements, and if they correspond, taking into account measuring uncertainties, then the next step is undertaken, and if they are different then the object is discarded.

10. The method as claimed in claim 9, wherein the surface appearance of this object is moreover subjected to control.

11. The method as claimed in claim 9, wherein, at the step for the structural analysis of said object, a first laser beam is directed onto said object in order to produce ultrasonic waves in said object to be inspected, said object is illuminated with a second laser beam such that part of this second beam is reflected by said object and this reflected part of the second beam is measured by interferometry, all of these laser beams passing through a same optical pickup.
